(19) United States
(12) Patent Application Publication
(10) Pub. No.: US 2006/0014626 A1
(43) Pub. Date: Jan. 19, 2006

(54) Tunable lossy dielectric ceramic material having ZrC as a dispersed second phase

(76) Inventor: Biljana Mikijelj, Cerritos, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 10/892,719

(22) Filed: Jul. 15, 2004

(51) Int. Cl. C04B 35/56; C04B 35/582

(52) U.S. Cl. 501/98.4; 501/98.5; 501/98.6; 501/87

(57) ABSTRACT

An aluminum nitride (AlN), alumina, magnesia, beryllia or other dielectric matrix with a ZrC dispersed phase is provided. Mixed powders of aluminum nitride or other dielectric phases and ZrC, with or without Y₂O₃, CaO, Li₂O, La₂O₃, and other rare earth metal oxides or mixtures thereof are formed by dry pressing (or isostatic pressing, injection molding or other similar methods known to those familiar with the art). Consolidation at high temperatures (and or pressures) to a virtually dense material with densities of over 95%, preferably higher than 97% of theoretical density can be attained by hot pressing, hip-ing, gas-pressure sintering or pressureless sintering (including microwave sintering). A controlled inert atmosphere is required to prevent the oxidation or other reaction of the carbide phase. Ar or similar atmosphere is preferred to avoid reactions with ZrC. Materials produced according to the invention can have real dielectric constants in at least the 8-40 range, with the loss tangents ranging from 0.01-0.3 at 2 GHz. The materials described have lossy properties over a wide frequency range (0.5 to over 20 GHz), and at temperatures from 2 K to above room temperature.

### BACKGROUND OF THE INVENTION

1. Field of the Invention

The present invention relates generally to the field of ceramic materials and more specifically to tunable lossy dielectric ceramic materials especially useful at high frequencies and at low temperatures.

2. Background

A limited number of high power particle accelerators (e.g., Continuous Electron Beam Accelerator Facility—CEBAF—at Jefferson National Accelerator Center, Newport News), operate at extremely low temperatures (2-4 K). For the accelerator's efficient operation, higher order mode (HOMs) microwave frequencies need to be damped (absorbed) at these temperatures.

### PRIOR ART

A range of AlN, Al₂O₃, BeO, MgO composites with SiC particulates have been used in the electron device industry for damping microwave frequencies at room temperature. These materials have been found to be ineffective at cryogenic temperatures.

In the early 1990's, Ceradyne, Inc. in collaboration with CEBAF (Newport News) developed an AlN—C (carbon) composite with lossy properties which extended to at least 2 K. However, this material's dielectric properties were restricted to e′ of about 20.

The current invention relates to a material based on a ZrC dispersoid in a dielectric matrix, the resulting material being lossy over an extremely wide temperature range, and the dielectric properties of which can be tailored over a wide range of e′.

### SUMMARY OF THE INVENTION

According to the present invention, a composite material formed of aluminum nitride (AlN), alumina (Al₂O₃), magnesia (MgO), beryllia (BeO) or other dielectric matrix, and dispersed ZrC particles is shown to have the desired properties. Materials such as Y₂O₃, CaO, Li₂O, or other rare earth oxides can be added to the compositions as sintering aids or thermal conductivity enhancers, but are not necessary for the material to have the lossy properties. Materials produced according to the invention can have real dielectric constants in at least the 8-40 range, with the loss tangents ranging from 0.01-0.3 at 2 Ghz with similar values at higher frequencies.

The materials described have lossy properties over a wide frequency range (0.5 to over 20 GHz), and at temperatures from 2 K to above room temperature. This allows the materials to be used in room temperature applications as well as cryogenic environments.

The material can be densified using hot pressing, gas-pressure or pressureless sintering in a protective atmosphere including microwave sintering.

### OBJECTS OF THE INVENTION

It is therefore a principal object of the present invention to provide a material which has the high loss tangent and high dielectric characteristics useful in the fabrication of high power particle accelerators, particularly for use at cryogenic temperatures.

It is yet another object of the invention to provide a predictably lossy ceramic material having selectable dielectric constant and loss tangent depending upon the relative loading of a dielectric matrix with a ZrC dispersed second phase.

It is yet another object of the invention to provide a lossy ceramic material which remains lossy at frequencies up to at least 20 GHz and at cryogenic temperatures.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1, comprising FIGS. 1a and 1b provides graphs illustrating dependence of real part of the dielectric permittivity (e′) and loss tangent-tg(δ)—as a function of ZrC loading, over a wide frequency range; and

FIG. 2 is a graph showing the AlN—ZrC material insertion loss in a waveguide, over a wide temperature range, showing no change in loss properties upon cooling.

### DETAILED DESCRIPTION OF THE PREFERRED EMBODIMENT

According to the present invention, an aluminum nitride (AlN), alumina, magnesia, beryllia or other dielectric matrix with a ZrC dispersed phase is provided. The material is formed by hot pressing, gas-pressure sintering or pressureless sintering (including microwave sintering). Mixed powders of aluminum nitride or other dielectric phases and ZrC, with or without Y₂O₃, CaO, Li₂O, La₂O₃, and other rare earth metal oxides or mixtures thereof are formed by dry pressing (or isostatic pressing, injection molding or other similar methods known to those familiar with the art). Consolidation at high temperatures (and or pressures) to a virtually dense material with densities of over 95%, preferably higher than 97% of theoretical density can be attained by hot pressing, hip-ing, gas-pressure sintering or pressureless sintering (including microwave sintering). A controlled inert atmosphere is required to prevent the oxidation of the carbide phase. Ar or similar atmosphere is preferred to avoid reactions with ZrC.

The ZrC content in the composite should not exceed 50 vol %, and should preferably be 0.1-25 vol %. The particle size of the ZrC powder should not exceed 60 μm and is preferably less than 25 μm in size. The sintering aid content (Y₂O₃, CaO, Li₂O, La₂O₃, and other rare earth metal oxides or mixtures thereof) effective in promoting densification and thermal conductivity is in the 0.00-10 wt % range, preferably in the 0.5-5% range. AlN powder with surface areas of over 1 m²/g are required for hot pressing, with surface areas higher than 2 m²/g required for sintering. Sintering aids powder (Y₂O₃ or other) should have a surface area over 2 m²/g, preferably over 8 m²/g.

### EXAMPLE 1

Several different samples of the composite material comprising of mixed AlN, ZrC and Y₂O₃ powders were formed using varying percentages of ZrC and Y₂O₃. Commercially available AlN, ZrC and Y₂O₃ powders were used. Powder mixing was accomplished using standard mixing techniques in a non-aqueous medium (isopropyl alcohol, hexane or similar). Powder was then dried, homogenized and screened. (Binders can be added to the powder, and the powder can be spray dried if required without deviating from the teachings of the invention.) The powder was then poured into a steel 4×4″ die, and uniaxially pressed to form a billet.

The billets were assembled into a graphite hot press die, and loaded into a hot pressing furnace. The billets were hot pressed in an inert atmosphere at temperatures from 1600-1950° C., and with applied pressures of 1000-4000 psi. The heating rates are dependent on the furnace and the load size, and temperatures holds in the 1650-1750° C. range are preferable in order to densify the material at the lowest possible temperature and reduce the reaction between the components.

Table 1 presents the results of some of the runs performed, and it shows dielectric properties, thermal conductivities and densities of the materials.

Materials described in Table 1 have been demonstrated to be vacuum compatible and they can be bonded to Cu or other metals.

TABLE 1
Dielectric properties and densities Measured on hot
pressed AIN-ZrC materials

| | | Maximum HP | Thermal | Relative |
|---|---|---|---|---|
| | e′/tg(δ) @ | temperature | Conductivity, | Density |
| % ZrC | 2 GHz | (° C.)/ref# | RT (W/mK) | (% Theoretical) |
| 5 | 9/0.03 | 1800 (99#10-15) | 123 | >99.5 |
| 10 | 13/0.04 | ″ | 104 | ″ |
| 15 | 16/0.06 | ″ | 91 | ″ |
| 20 | 28/0.15 | ″ | 80 | ″ |
| 23 | 55/0.16 | 1800 (99#11-5) | — | ″ |
| 26 | 45/0.13 | ″ | — | ″ |
| 1 | 8/0.02 | 1750 (00#02-22) | — | ″ |
| 2 | 9/0.02 | ″ | — | ″ |
| 4 | 10/0.02 | ″ | — | ″ |
| 6 | 11/0.02 | ″ | — | ″ |

### EXAMPLE 2

Several different samples of the composite material comprising mixed AlN, ZrC and Y₂O₃ powders were formed using varying percentages of ZrC and Y₂O₃. Commercially available AlN, ZrC and Y₂O₃ powders were used. Powder mixing was accomplished using standard mixing techniques in a non-aqueous medium (isopropyl alcohol, hexane or similar). Powder was then dried, homogenized and screened. (Binders can be added to the powder, and the powder can be spray dried if required without deviating from the teachings of the invention). The powder was then uniaxially pressed into pellets.

The pellets were subsequently pressureless sintered in a protective atmosphere at 1860° C. Table 2 shows that the resulting materials are lossy. It should be noted that further optimization of the raw powders, sintering temperature and material composition would result in improved material densities, but would not substantially alter the advantageous characteristics of the invention.

TABLE 2
Pressureless sintered AIN-ZrC composites (00#3-9)

| | | | |
|---|---|---|---|
| | | % Theoretical | |
| % ZrC | % Y₂O₃ | density | Is material lossy? |

| | | | |
|---|---|---|---|
| 1 | 4 | 99 | Yes |
| 6 | 4 | 95.3 | ″ |
| 26 | 5 | 90 | ″ |

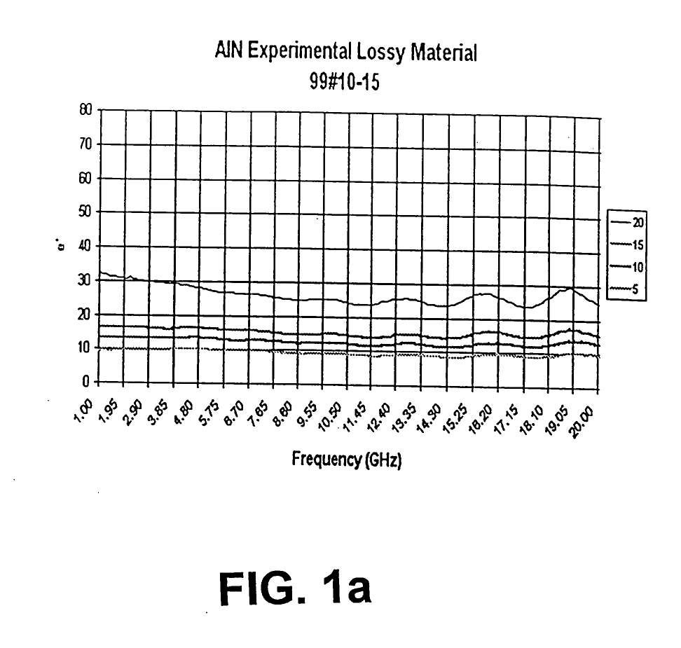

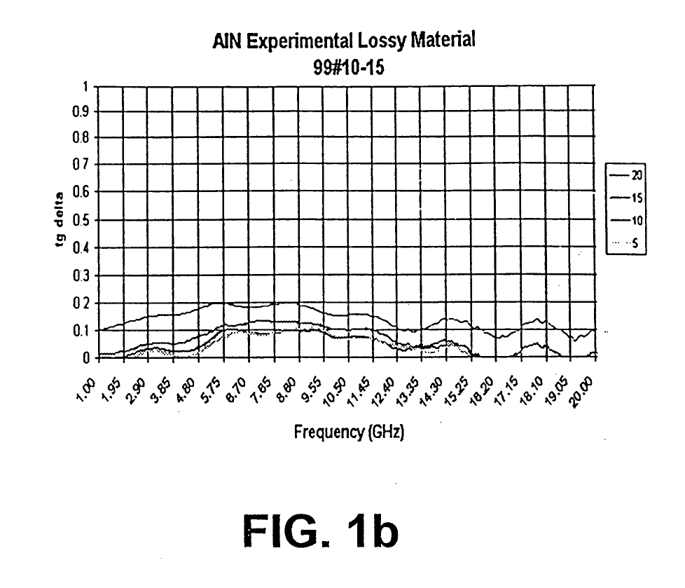

Materials produced according to the invention can have real dielectric constants in at least the 8-40 range, with the loss tangents ranging at least from 0.01-0.3 at 2 GHz (FIG. 1).

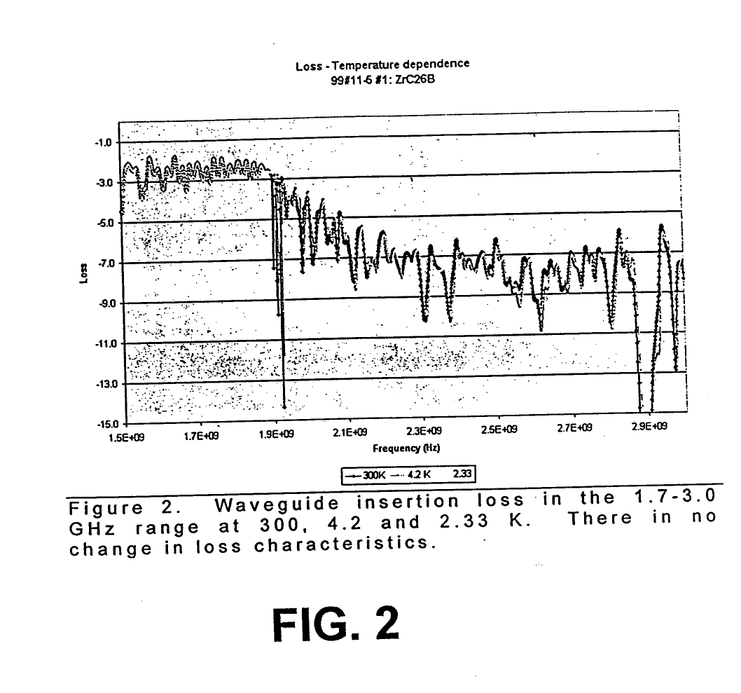

The materials described have lossy properties over a wide frequency range (0.5 to over 20 GHz), and at temperatures from 2 K to above room temperature (FIG. 2).

The Invention demonstrates that:

1. AlN—ZrC composites are lossy materials ranging from cryogenic to room temperatures, and that is can yield a range of dielectric properties custom tailored to the requirements.

2. Composites can be manufactured to have thermal conductivities over 70 W/mK, by using optimized amounts of sintering aids.

3. Dense AlN—ZrC composites can be manufactured consistently by hot pressing or sintering AlN—ZrC sintering aid powders in an appropriate inert atmosphere.

4. AlN—ZrC composites have more than sufficient strength to enable ceramic to metal bonding to Cu or other metals.

5. Due to its low porosity levels (high densities) the AlN—ZrC composites are vacuum compatible.

Having thus described preferred embodiments of the invention, it being understood that various modifications and additions are contemplated and will now be apparent to those having the benefit of the above disclosure, what is claimed is:

1. A lossy ceramic material which remains lossy over microwave frequencies and at room temperatures to cryogenic temperatures; the material comprising:
a dielectric matrix having a selected percentage of dispersed ZrC particles and densified to at least 90% of theoretical density.

2. The material recited in claim 1 wherein said dielectric matrix comprises AlN:

3. The material recited in claim 1 wherein said dielectric matrix comprises Al₂O₃.

4. The material recited in claim 1 wherein said dielectric matrix comprises MgO.

5. The material recited in claim 1 wherein said dielectric matrix comprises BeO.

6. The material recited in claim 1 further comprising a sintering aid.

7. The material recited in claim 1 wherein said dielectric matrix comprises about 20% to 99.8% by weight of said material.

8. The material recited in claim 1 wherein said ZrC particles comprises about 0.1% to 50% by volume of said material.

9. The material recited in claim 5 wherein said sintering aid is taken from the group consisting of Y₂O₃, La₂O₃ and other rare earth oxides, CaO, Li₂O and combinations thereof.

10. The material recited in claim 6 wherein said sintering aid comprises up to about 10% of said material by weight.

11. The material recited in claim 1 wherein said microwave frequencies are at least in the range of about 1.0 GHz to 20.0 GHz.

12. The material recited in claim 1 wherein said cryogenic temperatures are about 2K.

13. A lossy ceramic material having selectable lossy characteristics; the material comprising:
a dielectric matrix having a selected percentage of dispersed ZrC particles and densified to at least 90% of theoretical density;
the lossy characteristics of said material being determined by the percentage of dispersed particles of ZrC.

14. The material recited in claim 13 wherein said dielectric matrix comprises AlN.

15. The material recited in claim 13 wherein said dielectric matrix comprises Al₂O₃.

16. The material recited in claim 13 wherein said dielectric matrix comprises MgO.

17. The material recited in claim 13 wherein said dielectric matrix comprises BeO.

18. The material recited in claim 13 further comprising a sintering aid.

19. The material recited in claim 13 wherein said dielectric matrix comprises about 20% to 99.8% by weight of said material.

20. The material recited in claim 13 wherein said ZrC particles comprises about 0.1% to 50% by volume of said material.

21. The material recited in claim 18 wherein said sintering aid is taken from the group consisting of Y₂O₃, La₂O₃, rare earth oxides, CaO, Li₂O and combinations thereof.

22. The material recited in claim 18 wherein said sintering aid comprises up to about 10% of said material by weight.

23. The material recited in claim 13 wherein said lossy characteristics are substantially constant throughout a frequency range of 1.0 GHz to 20.0 GHz.

24. The material recited in claim 13 wherein said loss characteristics are substantially constant at temperatures between about 2K and room temperature.
